(19) United States
(12) Patent Application Publication
(10) Pub. No.: US 2016/0349020 A1
(43) Pub. Date: Dec. 1, 2016

(54) GIFT FOR CHILDREN

(71) Applicant: Michael Bickelmeyer, North Royalton, OH (US)

(72) Inventor: Michael Bickelmeyer, North Royalton, OH (US)

(21) Appl. No.: 14/726,657

(22) Filed: Jun. 1, 2015

(51) Int. Cl. F41H 13/00; G02B 23/16

(52) U.S. Cl. CPC F41H 13/0087; G02B 23/16

(57) ABSTRACT

This invention a weapon system is created to protect watch, and guard the free world. It is designed for development and use by the United States of America for the primary protection of those that prefer the confidence of safety and security. The function is to aid with the war on terrorism and drugs. This innovation is a defense system. The weapon system is designed to magnify sunrays from Earth's outer atmosphere. The operation of the weapon system is designed to be functional by both day and night. Through the use of reflective relay panels and Earth's outer atmosphere sunrays are directed to the weapon system. The sunrays pass through a chamber which contains a series magnification lens systems. The targeting system is designed to eliminate a single combatant with a variable expanding to eliminate entire countries. The weapon system is an apparatus which deals with satellite control systems. Implementation of the weapon system will be cost-effective to America and save American lives. This weapon system is not labor intensive. Because there is no use of nuclear technology this eliminates any radioactive nuclear fallout.

### TECHNICAL FIELD OF THE INVENTION

The present invention is a weapon system. More specifically the present invention is an aid to the United States of America with the war on terrorism and drugs. The invention endeavors satellite control systems. Through the use of magnified sunrays directed internally to the apparatus lens chamber, targeting systems direct magnified sunrays towards the earth can eliminate a single combatant with the variable to eliminate entire countries. Through the use of reflective relays the weapon system is operational during both day and night.

### BACKGROUND OF THE INVENTION

This invention is created to protect watch, and guard the free world. It is designed for development and use by the United States of America for the primary protection of those that prefer the confidence of safety and security. The function is to aid with the war on terrorism and drugs. This innovation is a defense system.

### SUMMARY OF THE INVENTION

This invention, the substance and idea is an innovation designed specifically to ensure for the children of today a safe, and secure tomorrow. A device designed to keep families together without separation. This invention is designed for pest control elimination. This device when used, can ensure a clean pollution free environment, without any radioactive nuclear fallout. It can be remote activated from any location. This invention is created to protect watch, and guard the free world. It is designed for development and use the United States of America for the primary protection of those that prefer the confidence of safety and security. The function is to aid with the war on terrorism and drugs. This innovation is a defense system.

### BRIEF DESCRIPTION OF THE DRAWINGS

The structure operation, and advantages of the present invention will become further apparent upon consideration of the following description taken in conjunction with the accompanying figures (FIGS.). The figures are intended to be illustrative, not limiting. Certain elements in some of the figures may be omitted, or illustrated not-to-scale, for illustrative clarity. The cross-sectional views may be viewed in the form of “slices”, or “nearsighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they intended merely as an aid to the reader, and should not in any way be interpreted as limiting.

### BRIEF DESCRIPTION OF THE SEVERAL VIEWS OF THE DRAWINGS

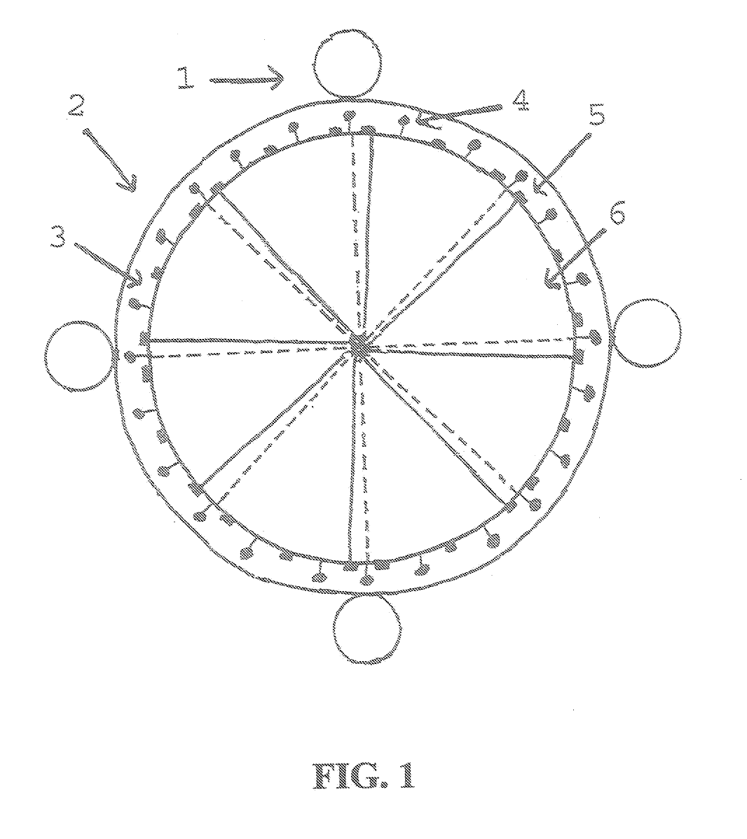

This is a description of drawing FIG. 1/12. Element 1 is a sighting system. There are four sighting systems shown. They are exactly 90° to each other from the center of element 6 protective shroud system. Element 2 is the external shell of the main long apparatus system. Element 3 is the main long apparatus system mechanisms functions chamber. It runs throughout the entire length of the main long apparatus system, and each of all for sighting systems are alike the main long apparatus system. Element 4 is a shroud motor. There are three motors for each shroud plate on all for sighting systems. Each motor has in itself enough torque to raise and lower the shroud plate. Element 5 is a shroud plate hinge. Each shroud plate has three hinges. Each hinge on every shroud plate is capable of the total motion individually. All four sighting systems have the exact hinge configuration as the main long cylinder apparatus. Element 6 is a protective shroud section plate. All four targeting site systems have protective shroud sections.

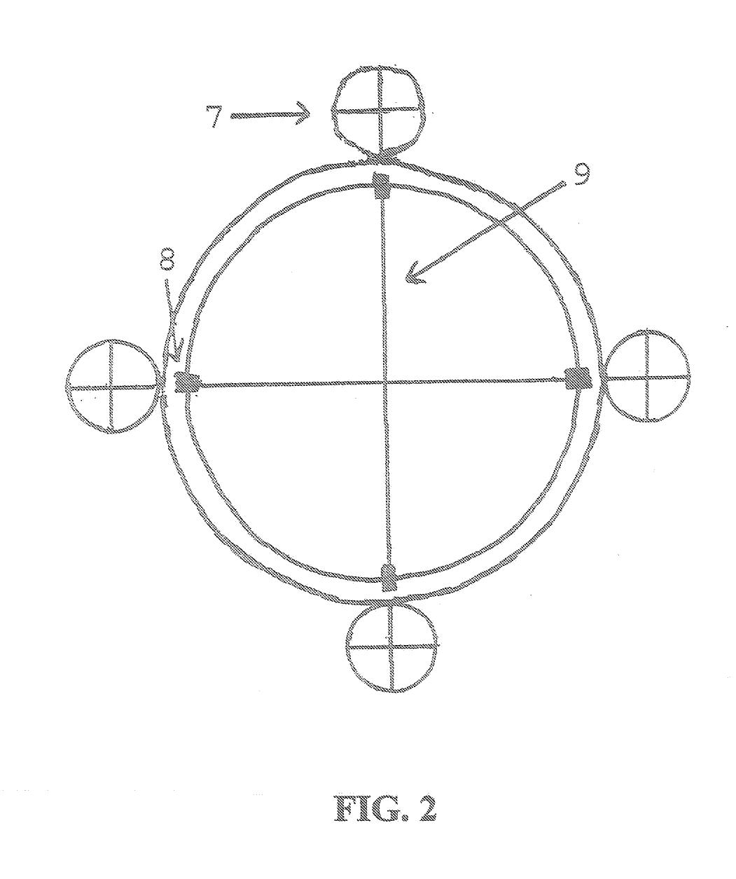

This is a description of drawing FIG. 2/12. Element 7 is a sight alignment system. There are four sight alignment systems on the outside perimeter of the main long cylinder apparatus system. Each of all for sight alignment systems are in alignment with the main long cylinder crosshair system as as center. Element 8 is a mechanical system for which the lens and sight system travel. There are four travel mechanisms for the main long apparatus system. The four travel mechanisms are each individually spaced at 90° to each other from the center crosshair of the main long cylinder apparatus system. The four individual sight systems are identical to this configuration. Element 9 is the main long cylinder apparatus targeting sight system.

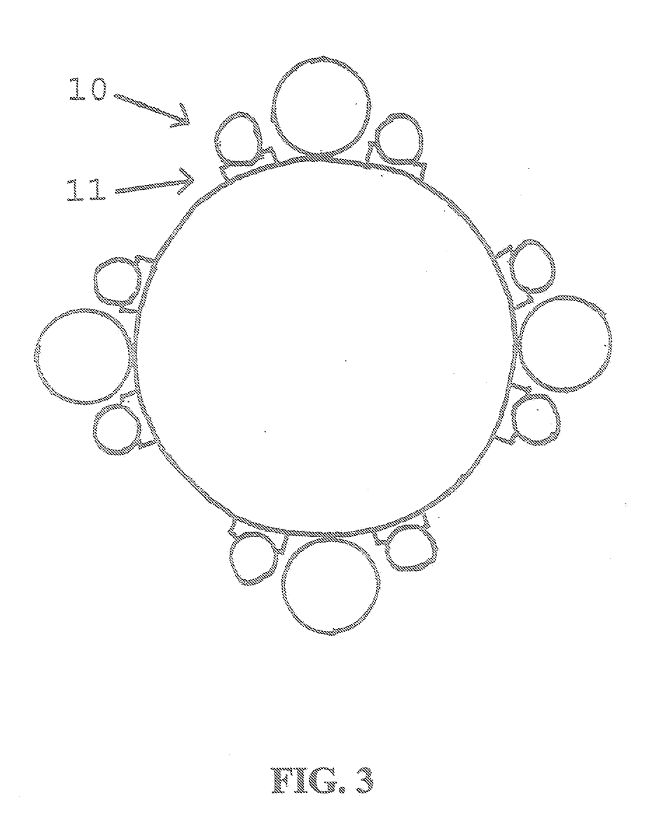

This is a description of drawing FIG. 3/12. Element 10 is a motor system. There are series of eight motor systems visible on FIG. drawing 3/12. There are a series of motor systems on either side of all our targeting systems. These targeting systems are defined in FIG. drawing 1/12, element 1 and FIG. drawing 2/12, element 7. These motor systems operate the functions of the main long cylinder apparatus lens systems and targeting sight systems. They are present in drawing FIG. 3/12, element 10 and each of all four targeting sight systems. Element 11 is a mount for the motor and motors for the mechanical operations of the main long cylinder apparatus and targeting systems.

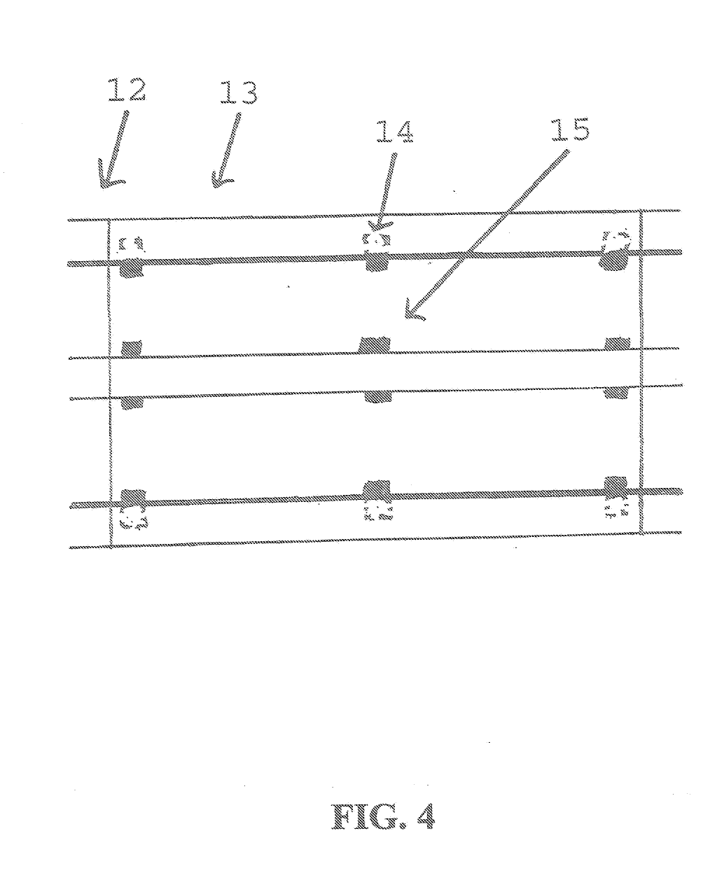

This is a description of drawing FIG. 4/12. Drawing FIG. 4/12 is a split view of the main long cylinder apparatus and targeting sighting alignment systems. Element 12 are fixed extensions of the lens sight alignment systems. Element 13 is a sight alignment system. This split view shows three of the total of the four. Element 14 is a nonvisible mount for the sight alignment targeting system. Element 15 is a visible mount for fastening the targeting sighting alignment system to the frame of the main long cylinder apparatus system.

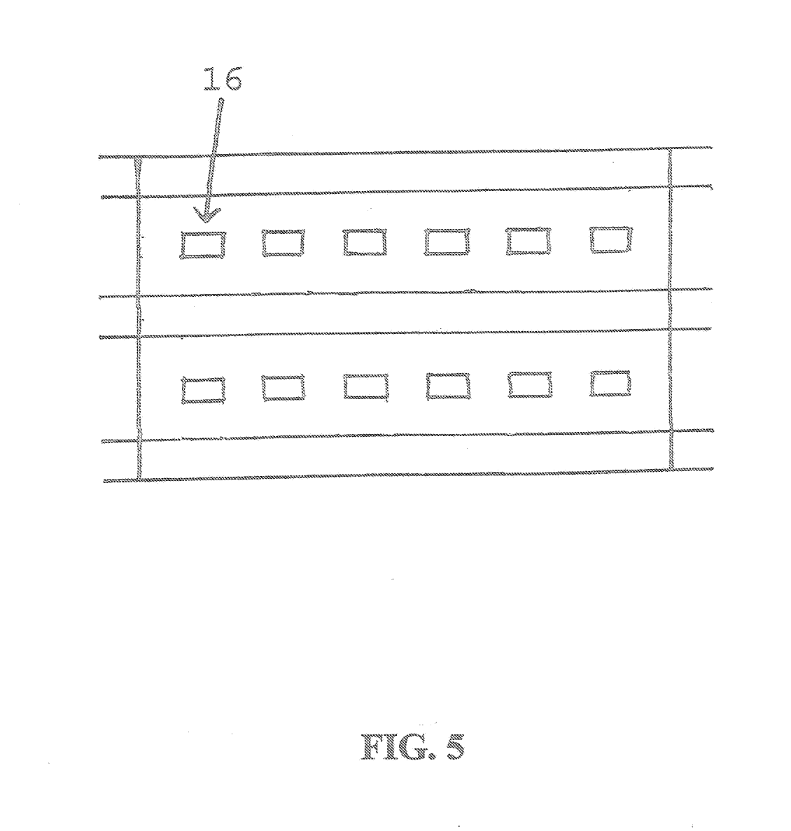

This is a description of drawing FIG. 5/12. Element 16 is a maintenance hatch system on the main long cylinder apparatus. They are also on each of all four targeting sighting alignment systems.

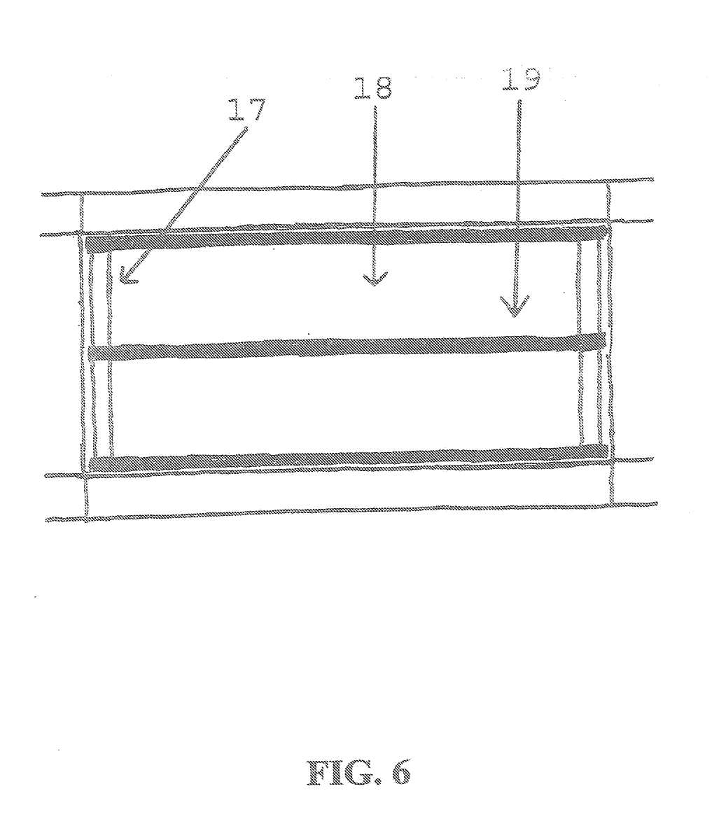

This is a description of drawing FIG. 6/12. Element 17 is a lens. There is a lens series at the forward and at of the lens chamber at the main long cylinder apparatus. Element 18 is the lens chamber. Element 19 is a motorized rail for the lens systems to travel on.

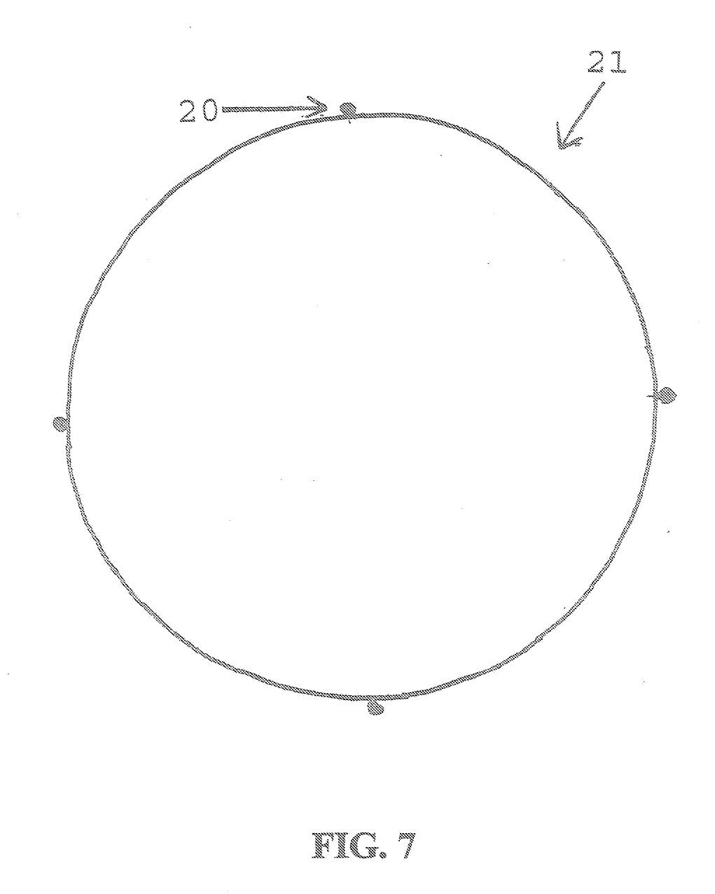

This a description of drawing FIG. 7/12. Element 20 is a mount on the reflective transfer located on the aft or farthest from the Earth's end long ways of the main long cylinder apparatus. Element 21 is the round configuration of the reflective transfer.

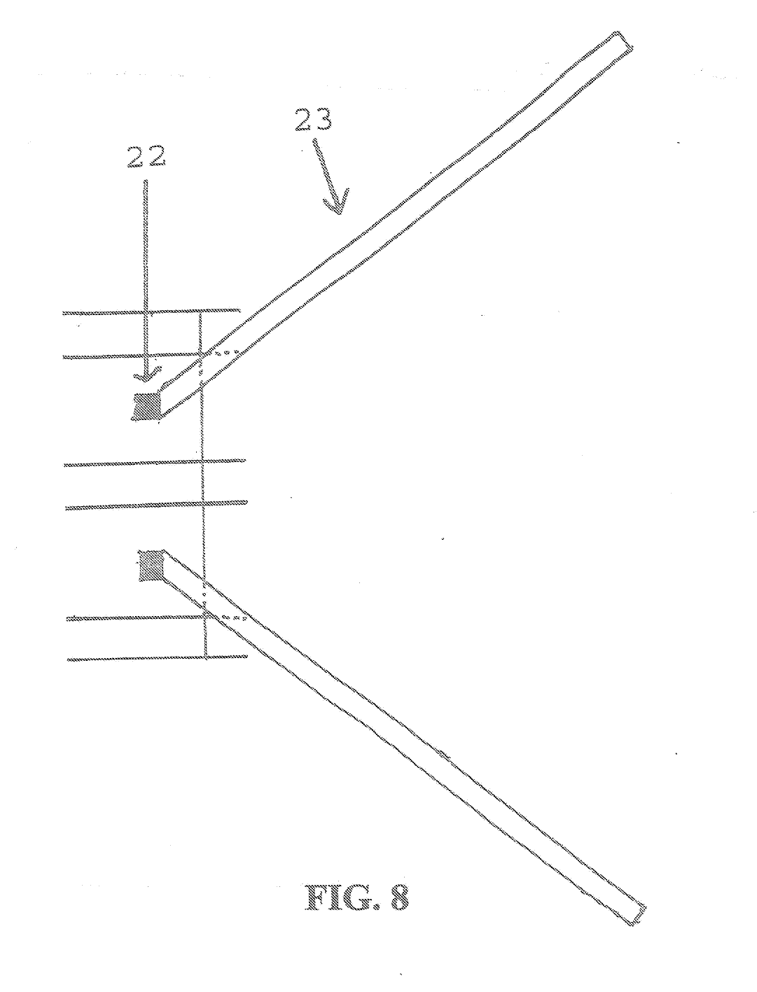

This is a description of drawing FIG. 8/12. Drawing FIG. 8/12 shows a split view of the aft intake farthest from the earth end long ways of the main long cylinder apparatus. Element 22 is a rotational mounting system for one of our adjustable arms which control the round reflective transfer relay element. Element 23 is one of four arms used to move the round reflective transfer relay.

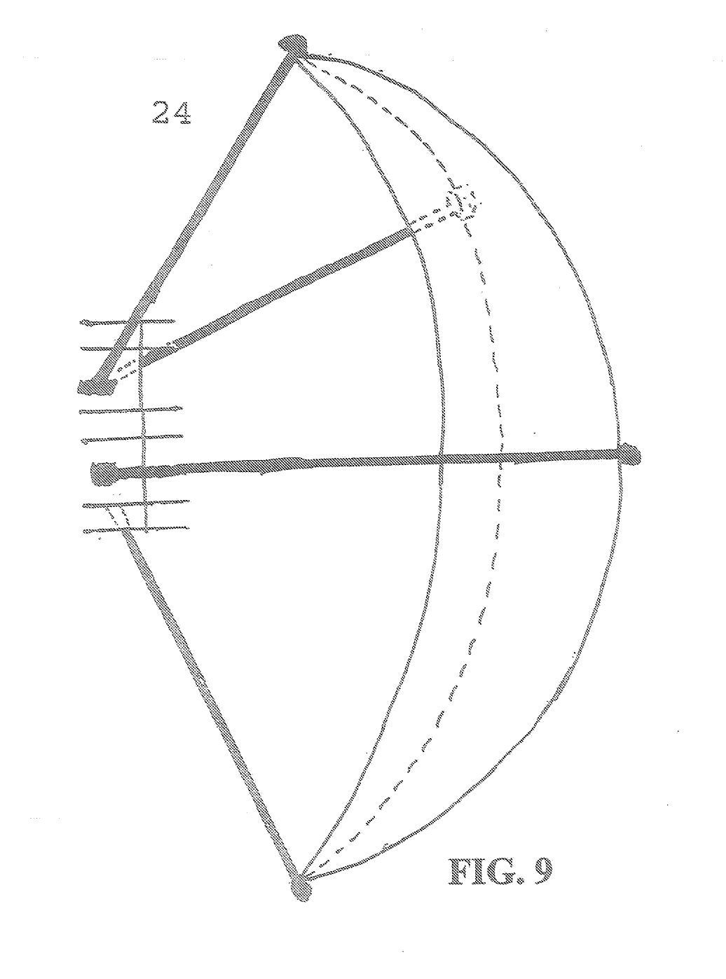

This is a description of drawing FIG. 9/12. Element 24 is a round reflective relay transfer. It is fastened to the main long cylinder apparatus by four movable arms which are fastened to the aft or farthest from the earth end long ways of the main long cylinder apparatus.

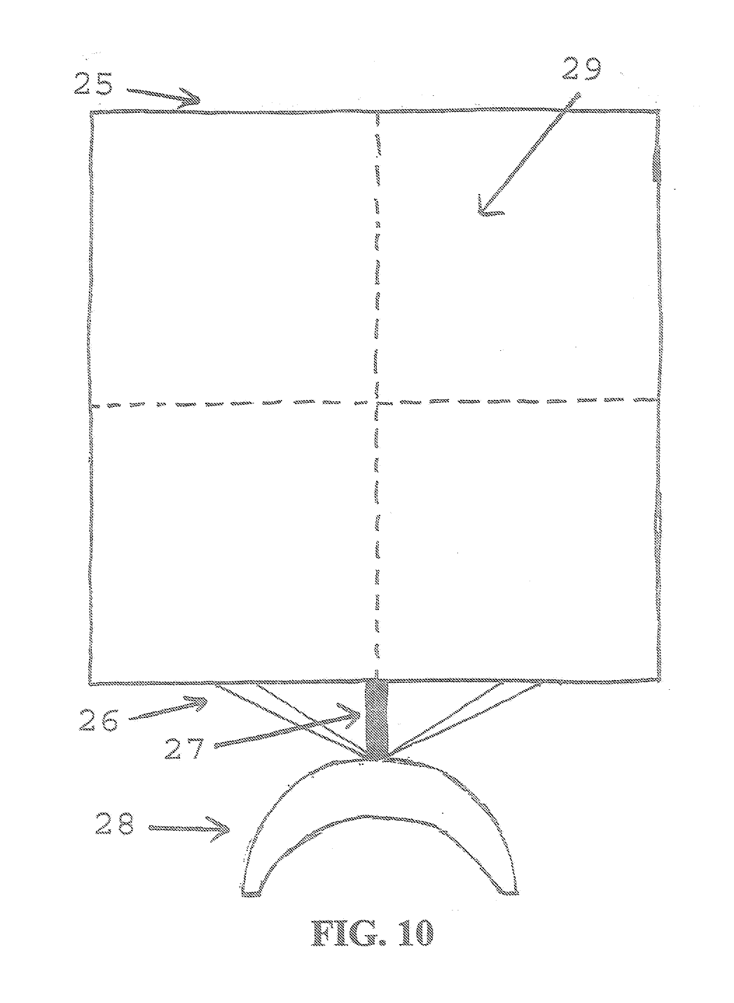

This is a description, of drawing FIG. 10/12. Drawing FIG, 10/12 is a square reflective transfer. Element 25 is a square shaped reflective transfer. Element 26 is a movable arm which controls both the reflective transfer panels and radio receptive element. Element 27 is a radio receptive element stem. Element 28 is radio receptive element. Element 29 is a reflective adjustable relay transfer panel.

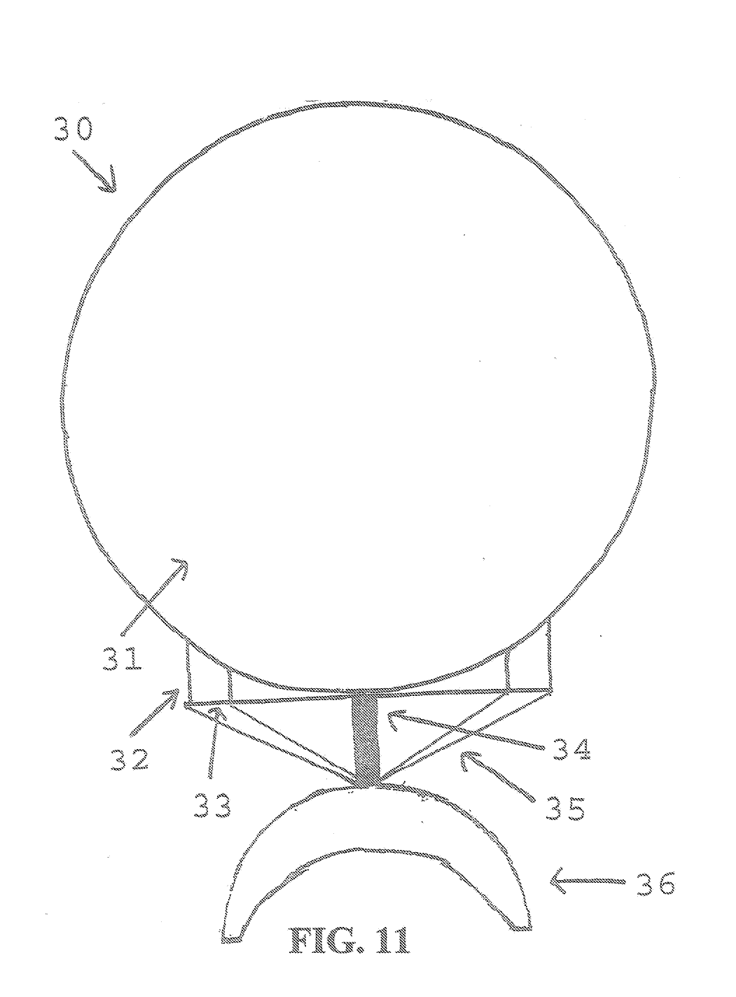

This is a description of drawing FIG. 11/12. Element 30 is a round reflective transfer relay. Element 31 as an oval transfer reflective relay panel. Element 32 is a movable atm connecting the oval transfer reflective relay panel to the radio receptive element. Element 33 is a variable position point for the movable arm connecting the oval transfer reflective relay panel to the radio receptive element. Element 34 is a stem position arm fastening the oval transfer reflective relay panel to the radio receptive element. Element 35 is an angled movable arm. Element 36 is a radio receptive element.

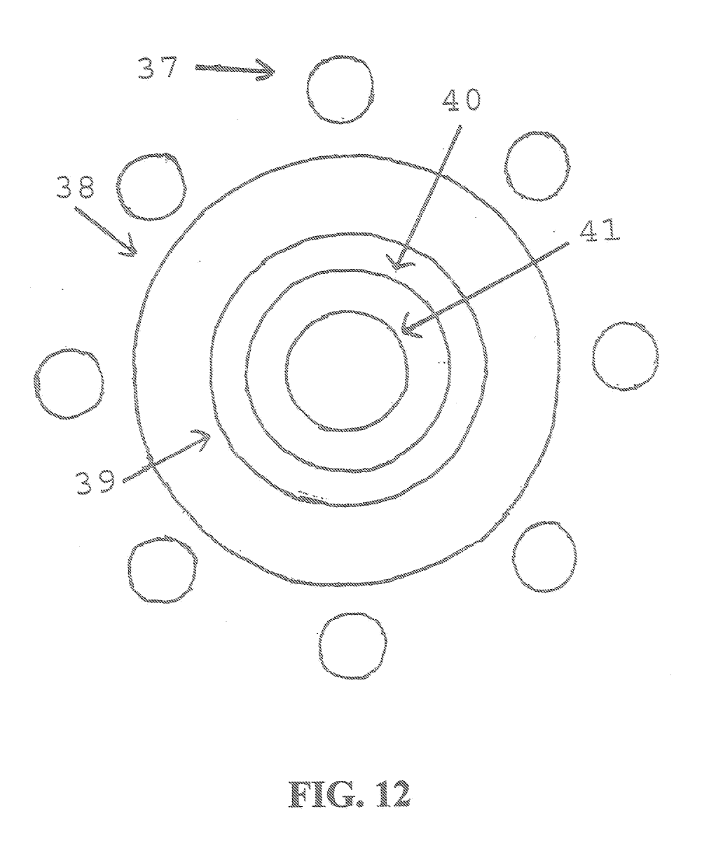

This is a description of drawing FIG. 12/12. Element 37 are sun positions. Element 38 is an orbit for the main long cylinder apparatus and reflective relay transfer systems. Element 39 is in orbit for the main long cylinder apparatus and reflective relay transfer systems. Element 40 is an orbit for the main long cylinder apparatus and reflective relay transfer systems. Element 41 is the earth.

### DETAILED DESCRIPTION OF THE INVENTION

This invention, the substance and idea is an innovation designed specifically to ensure for the children of today a safe and secure tomorrow. A device designed to keep families together without separation. This invention is designed for pest-control illumination. This device when used can ensure a clean pollution free environment without any radioactive nuclear fallout. It can be remote activated from any location. This invention is created to protect watch, and guard the free world. It is designed for development and use by the United States of America for the primary protection of those that prefer the confidence of safety and security. The function is to aid with the war on terrorism and drugs. This innovation is a defense system. An evolutionary device designed to guard, and protect children by day and night. A device designed to let allow, and permit children to enjoy a spring breeze, play with the leaves of fall, and feel the bite of winter upon their faces, in a carefree manner without concerns. This invention is designed to erase from the world, the spirits of dread and nightmare. The using of this invention is the magnification of sunrays from a point external from the earth, to erase from the world the spirits of dread nightmare, and utilize pest-control. Sunrays are directed to the aft, farthest from Earth by a reflective transfer and combination of reflective transfer combination relays, from a series of locations around the earth. These transfers of rays are from the sun. This invention is a technological advance in warfare defense systems.

The application is intended for use by the United States of America to assist with the war on terrorism and drugs. This device is designed to keep families together without separation. This device is designed to eliminate targets without any radioactive nuclear fallout. This device is designed to eliminate the loss of American lives. This device saves time and labors. This device is cost-effective. Control and manipulation of this apparatus and reflective relays can be from remote location and locations such as Earth, space, and outer spheres. These magnified sunrays when exited through its forward or closest to the earth end side long ways from the apparatus be strategically placed to its targeted spirits of dread and nightmare, and utilized for pest-control, to totally eliminate them. This device is designed to keep families together without separation. This invention is created for pest-control elimination. The process of making this invention is through mold configuration process. These sunrays can be directed to its target and targets, through a series of four magnified external sights fastened to the exterior of the cylinder shaped apparatus, parallel to it. These sights are exactly 90° to each other, from the center crosshair alignment of the main long cylinder apparatus. All four sight systems are exactly similar in construction elements as the main apparatus long cylinder. This apparatus and its functions can be performed in addition from the main apparatus cylinder earth space outer spheres, and also from all reflective relays by remote wave, and satellite control systems. These reflectors are manipulated position capable, and are controllable from Earth space, and outer spheres. The main long cylinder apparatus and all reflective relays are also manual control capable, at the location and locations. Implementation of the weapon system is cost-effective to America and will save American lives. This defense system is not labor intensive. The weapon system is designed to magnify sunrays from Earth's outer atmosphere. The operation of this weapon system is designed to be functional by both day and night. Through the use of reflective panels and Earth's outer atmosphere sunrays are directed to the weapon system. The sunrays pass through a chamber which contains a series magnification lens systems. The targeting system is designed to eliminate a single combatant with a variable expanding to eliminate entire countries. Because there is no use of nuclear technology this eliminates any radioactive nuclear fallout.

1. A weapon system utilizing a main long cylinder with a lens magnification chamber.

2. A weapon system utilizing a main long cylinder which magnified ultraviolet sun rays pass through.

3. A weapon system utilizing maintenance hatch systems.

4. A weapon system utilizing a motorized protective shroud systems.

5. A weapon system utilizing a main long cylinder with an oval adjustable reflective transfer.

6. A weapon system utilizing square shaped reflective transfer relays.

7. A weapon system utilizing oval shaped reflective transfer relays.
